(19) United States
(12) Patent Application Publication
(10) Pub. No.: US 2015/0106005 A1
(43) Pub. Date: Apr. 16, 2015

(54) METHODS AND SYSTEMS FOR AVOIDING A COLLISION BETWEEN AN AIRCRAFT ON A GROUND SURFACE AND AN OBSTACLE

(71) Applicant: Gulfstream Aerospace Corporation, Savannah, GA (US)

(72) Inventor: Carl Edward Wischmeyer, Savannah, GA (US)

(73) Assignee: Gulfstream Aerospace Corporation, Savannah, GA (US)

(21) Appl. No.: 14/053,380

(22) Filed: Oct. 14, 2013

(51) Int. Cl. G08G 5/06

(52) U.S. Cl. CPC G08G 5/065
USPC 701/301

(57) ABSTRACT

The disclosed embodiments relate to methods and systems for avoiding a collision between an aircraft on the ground and an obstacle. The method includes receiving a direction signal from a sensor indicating the forward direction of the aircraft and receiving a video image from a camera representing a field of view from a wingtip of the aircraft. Using this information, a processor determines a predicted path through which the wingtip of the aircraft will travel based upon the direction signal. The video image is displayed together with an overlay representing the predicted path within the field of view. In this way, the overlay provides information to assist in preventing the aircraft from colliding with obstacles in the field of view.

### TECHNICAL FIELD

Embodiments of the present invention generally relate to aircraft, and more particularly relate to methods and systems for avoiding collisions between an aircraft on a ground surface and an obstacle.

### BACKGROUND OF THE INVENTION

An operator of an aircraft must often maneuver the aircraft while on the ground. This may happen during ground operations such as when the aircraft is taxiing, being maneuvered to or from a hangar, or backing an aircraft away from a terminal

Obstacles on the ground, such as structures, other aircraft, vehicles and other obstacles, may lie in the path of a taxing aircraft. Operators are trained to detect these obstacles using their sense of sight. However, in many cases, due to the dimensions of the aircraft (e.g., large wing sweep angles, distance from cockpit to wingtip, etc.) and the operator's limited field of view of the areas surrounding the aircraft, it can be difficult for an operator to monitor extremes of the aircraft during ground operations. As a result, the operator may fail to detect obstacles that may be in the path of the wingtips of the aircraft. In many cases, the operator may only detect an obstacle when it is too late to take evasive action needed to prevent a collision with an obstacle.

Collisions with an obstacle can not only damage the aircraft, but can also put the aircraft out of service and result in flight cancellations. The costs associated with the repair and grounding of an aircraft can be significant. As such, the timely detection and avoidance of obstacles that lie in the ground path of an aircraft is an important issue that needs to be addressed.

Accordingly, it is desirable to provide methods, systems and apparatus that can reduce the likelihood of and/or prevent collisions between aircraft and obstacles. It would also be desirable to assist the operator with maneuvering the aircraft and to provide an operator with aided guidance while maneuvering the aircraft so that collisions with such obstacles can be avoided. It would also be desirable to provide technologies that can be used to detect obstacles on the ground and identify an aircraft's current and predicted position with respect to the detected obstacles. It would also be desirable to provide the operator with an opportunity to take appropriate steps to avoid a collision from occurring between the aircraft and the detected obstacles. Furthermore, other desirable features and characteristics of the present invention will become apparent from the subsequent detailed description and the appended claims, taken in conjunction with the accompanying drawings and the foregoing technical field and the foregoing technical field and background.

### SUMMARY

In one embodiment, a method is provided for avoiding a collision between an aircraft on a ground surface and an obstacle, the method includes receiving a direction signal from a sensor indicating the forward direction of the aircraft and receiving a video image from a camera representing a field of view from a wingtip of the aircraft. Using this information, a processor determines a predicted path through which the wingtip of the aircraft will travel based upon the direction signal. The video image is displayed together with an overlay representing the predicted path within the field of view. In this way, the overlay provides information to assist in preventing the aircraft from colliding with obstacles in the field of view.

In another embodiment, a system is provided. The system includes a sensor providing a direction signal indicating a forward direction of the aircraft; and a camera for providing video image within a wingtip field of view of the aircraft. A processor determines a predicted path for a wingtip of the aircraft within the wingtip field of view based upon the direction signal and for generating an overlay image representing the predicted path. The video image and the overlay are displayed to provide information to assist in avoiding obstacles.

### DESCRIPTION OF THE DRAWINGS

Embodiments of the present invention will hereinafter be described in conjunction with the following drawing figures, wherein like numerals denote like elements, and

FIGS. 1A and 1B are illustrations of an aircraft in accordance with an embodiment;

FIG. 2 is a block diagram of flight control systems in accordance with an embodiment;

FIGS. 3-5 are illustrations of displays of an aircraft in accordance with an embodiment;

FIG. 6 is an illustration of an aircraft under tow in accordance with an embodiment; and

FIG. 7 is a flowchart of a method in accordance with an embodiment.

### DESCRIPTION OF EXEMPLARY EMBODIMENTS

As used herein, the word “exemplary” means “serving as an example, instance, or illustration.” The following detailed description is merely exemplary in nature and is not intended to limit the invention or the application and uses of the invention. Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims. Furthermore, there is no intention to be bound by any expressed or implied theory presented in the preceding technical field, background, summary or the following detailed description.

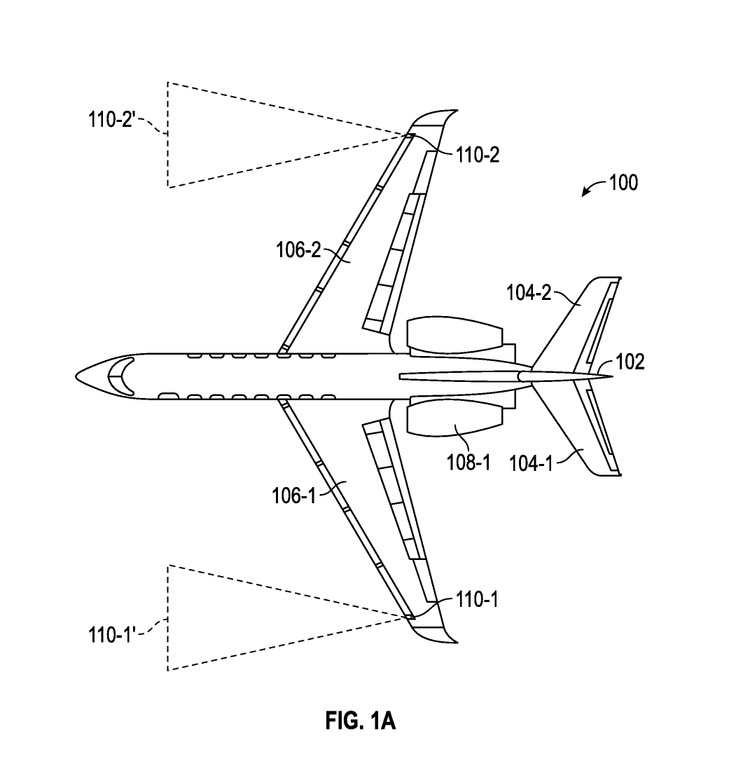

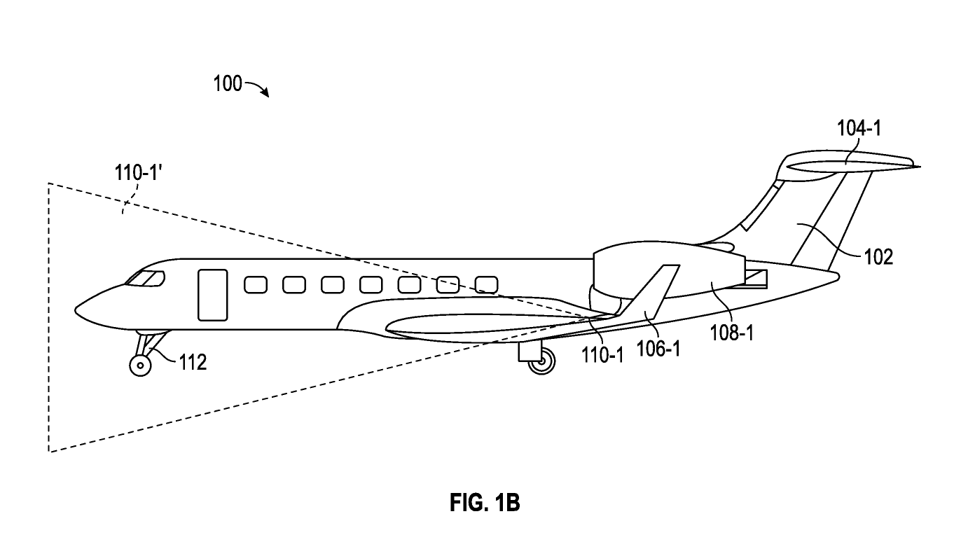

FIGS. 1A and 1B, illustrate an aircraft 100 that includes instrumentation for implementing an optical wingtip monitoring system in accordance with some embodiments. As will be described below, the wingtip monitoring system can be used to reduce or eliminate the likelihood of a collision between an aircraft 100 with obstacles that are in the wingtip path of the aircraft when the aircraft is taxiing.

In accordance with one non-limiting embodiment, the aircraft 100 includes a vertical stabilizer 102, two horizontal stabilizers 104-1 and 104-2, two main wings 106-1 and 106-2, two jet engines 108-1, 108-2, and an optical air traffic detection system that includes cameras 110-1, 110-2 that are positioned approximately at the wingtips of the aircraft 100. Although the jet engines 108-1, 108-2 are illustrated as being mounted to the fuselage, this arrangement is non-limiting and in other implementations the jet engines 108-1, 108-2 can be mounted on the wings 106-1, 106-2. Also, the respective locations of the illustrated cameras 110-1, 110-2 are non-limiting, but generally, are positioned to provide a wingtip field of view (110-1′, 110-2′) of the starboard and port wing of the aircraft. In some embodiments, the cameras 110-1, 110-2 may be positioned substantially at the wingtips of the aircraft. In some embodiments (for example, due to physical space requirements or flared wingtip designs as shown) the cameras 110-1, 110-2 may be positioned at a known distance from the actual wingtip. This allows for compensation between the center of the field of view of the cameras and the actual wingtip in the displayed images as will be discussed in more detail below.

The cameras 110-1, 110-2 are used to acquire video images of a field of view (FOV) 110-1′, 110-2′. In some embodiments, the cameras 110-1, 110-2 are video cameras capable of acquiring video images with the FOV at a selected frame rate (e.g., thirty frames per second). In some embodiments, the cameras 110-1, 110-2 are still image cameras that can be operated at a selected or variable image capture rate according to a desired image input rate. Additionally, the cameras 110-1, 110-2 may be implemented using cameras such as high-definition cameras, video with low-light capability for night operations and/or cameras with infrared (IR) capability, etc. In some embodiments, multiple cameras may be employed and the respective FOVs combined or “stitched” together using convention virtual image techniques.

In some embodiments, the FOVs 110-1′, 110-2′ may vary depending on the implementation and design of the aircraft 100 so that the FOV can be varied either by the operator (pilot) or automatically depending on other information. In some embodiments, the FOVs 110-1′, 110-2′ of the cameras can be fixed, while in others it can be adjustable. For example, in one implementation, the cameras 110-1, 110-2 may have a variable focal length (i.e., a zoom lens) which can be modified to vary the FOV 110-1′, 110-2′. Thus, this embodiment can vary the range and field of view based on the surrounding area and/or the speed of the aircraft so that the location and size of the space within the FOV 110-1′, 110-2′ can be varied. When the cameras 110-1, 110-2 have an adjustable FOV, a processor (not illustrated in FIGS. 1A-1B) can command the camera lens to a preset FOV. The optical range of the cameras 110-1, 110-2 can also vary depending on the implementation and design of the aircraft 100.

According to exemplary embodiments, a sensor onboard the aircraft 100 is used to provide a direction signal indicating the forward direction and steering direction of the aircraft. In some embodiments, the sensor employed in a yaw sensor (not shown in FIGS. 1A-1B) and in some embodiments a landing gear direction or steering sensor 112 is employed. By knowing the direction that the aircraft 100 will move when taxiing, an onboard computer can predict a path through which the wingtips of the aircraft will travel. Using this information, an overlay image is generated to be displayed with the video image from the cameras 110-1, 110-2. The combined image provides an operator (e.g., pilot) with a visual indication of the wingtip path, and any obstacles that may collide with the wings (or wingtips) can be seen by the operator to safely avoid collision with the obstacle. Non-limiting examples of the disclosed wingtip monitoring system include displaying a substantially straight line representing the wingtip path within the FOV when the sensor indicates that the aircraft is generally headed in a straight forward direction. When the aircraft begins to turn (port or starboard), an arced line indicative of the arced path the wingtip will take through the FOV is displayed. In this way, aircraft safety is promoted by providing information to assist in avoiding obstacles while the aircraft 100 is taxiing.

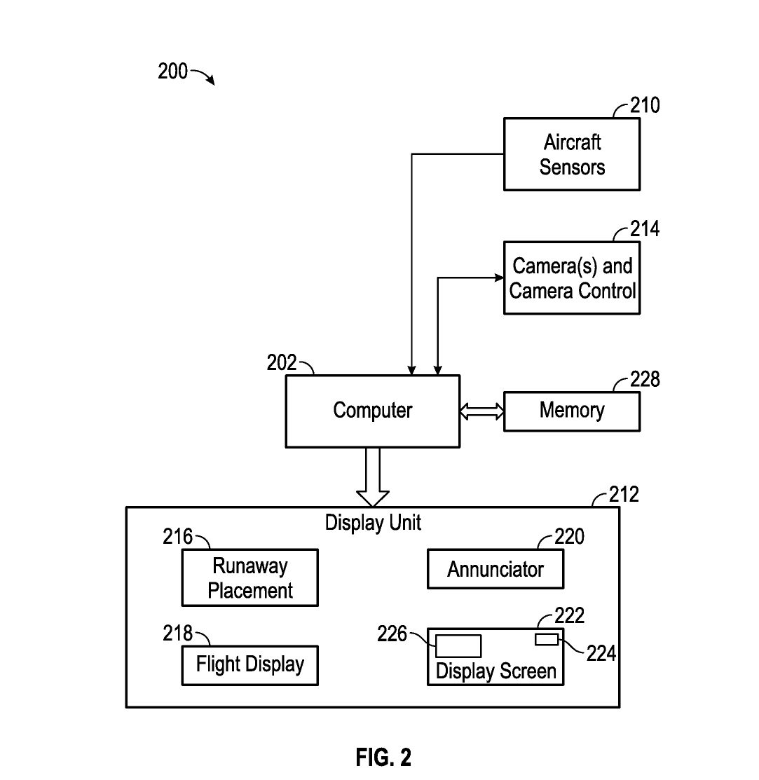

FIG. 2 is block diagram of various systems 200 for an aircraft 100 that implements an optical wingtip monitoring system and/or is capable of an optical wingtip monitoring method in accordance with exemplary embodiments. The various flight control systems 200 includes a computer 202, various sensors 210, cameras and camera control 214, memory 228 and a display unit 212.

Accordingly to exemplary embodiments, the cameras 110-1, 110-2 and camera control 214 provide raw or processed camera images to the computer 202. In some embodiments, raw images can be sent to the computer 202 for processing in a software embodiment. In some embodiments, hardware, firmware and/or software process the raw image data via the camera control 214 and provide processed image data to the computer 202. In other embodiments, the camera control 214 can be configured to send processed image data directly to the display 212.

Aircraft sensors 210 consist of a plurality of sensors including conventional yaw rate sensors and landing gear direction or steering sensors (112 in FIG. 1B) that provide a direction signal indicating the forward direction (and steering) of the aircraft 100. The computer 202 uses this information to predict a path through which the wingtips of the aircraft will travel within the FOVs cameras 110-1′, 110-2′ and to generate an overlay image to be displayed with the video image from the cameras 110-1, 110-2.

The display unit 212 displays information regarding the status of the aircraft including the FOVs from the cameras 110-1, 110-2 and the overlays. The display unit 212 typically also includes, but is not limited to an annunciator 220 to provide verbal warnings, alert or warning tones or other audible information. The display screen 222 of the display unit 212 may include pilot head-up display, traffic collision avoidance display or other displays as may be included in any particular embodiment. Some displays 222 include icons 224 that are illuminated to indicate the occurrence of certain conditions and/or a text message screen 226 to display text information.

In accordance with one embodiment, the various aircraft systems 200 illustrated in FIG. 2 is implemented with software and/or hardware modules in a variety of configurations. For example, computer 202 comprises a one or more processors, software module or hardware modules. The processor(s) reside in single integrated circuits, such as a single or multi-core microprocessor, or any number of integrated circuit devices and/or circuit boards working in cooperation to accomplish the functions of the computer 202. The computer 202 is operable coupled to a memory system 228, which may contain the software instructions or data for the computer 202, or may be used by the computer 202 to store information for transmission, further processing or later retrieval. In accordance with one embodiment, the memory system 228 is a single type of memory component, or composed of many different types of memory components. The memory system 228 can include non-volatile memory (e.g., Read Only Memory (ROM), flash memory, etc.), volatile memory (e.g., Dynamic Random Access Memory (DRAM)), or some combination of the two. In an embodiment, the optical air traffic detection system is implemented in the computer 202 via a software program stored in the memory system 228.

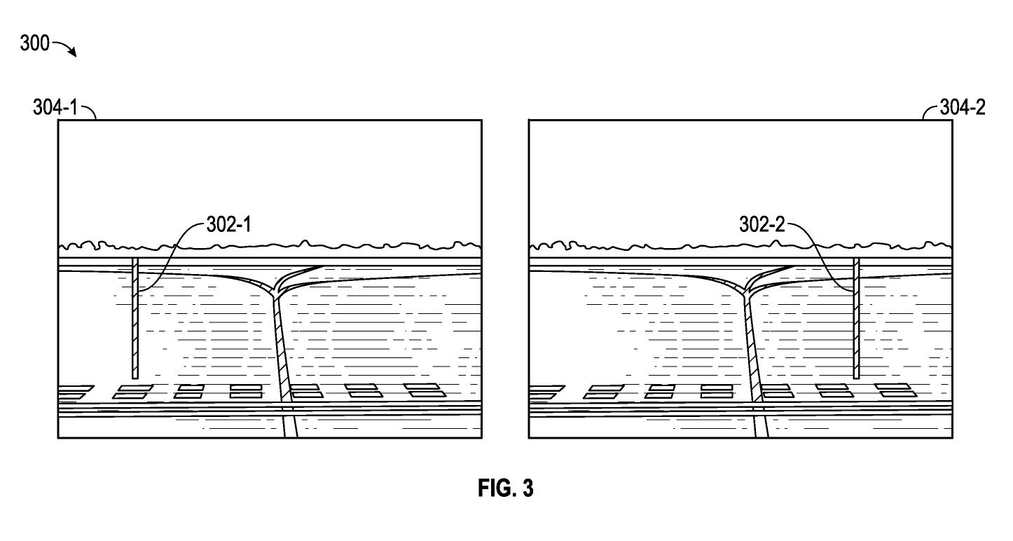

Once the predicted path of the wingtips has been determined and the overlays generated they can be presented to the aircraft operator on the display 212. FIGS. 3-5 are illustrations of some exemplary displays that could be employed in any particular implementation. In FIG. 3, a display 300 presents the overlays 301-1, 302-2 within the FOVs 304-1, 304-2. In the example of FIG. 3, the overlays 301-1, 302-2 are displayed as substantially straight lines indicating that the aircraft is headed in a substantially straight direction. Additionally, the icons could include a color feature, such as, for example, a green color, amber color or a red color depending upon the ground speed of the aircraft.

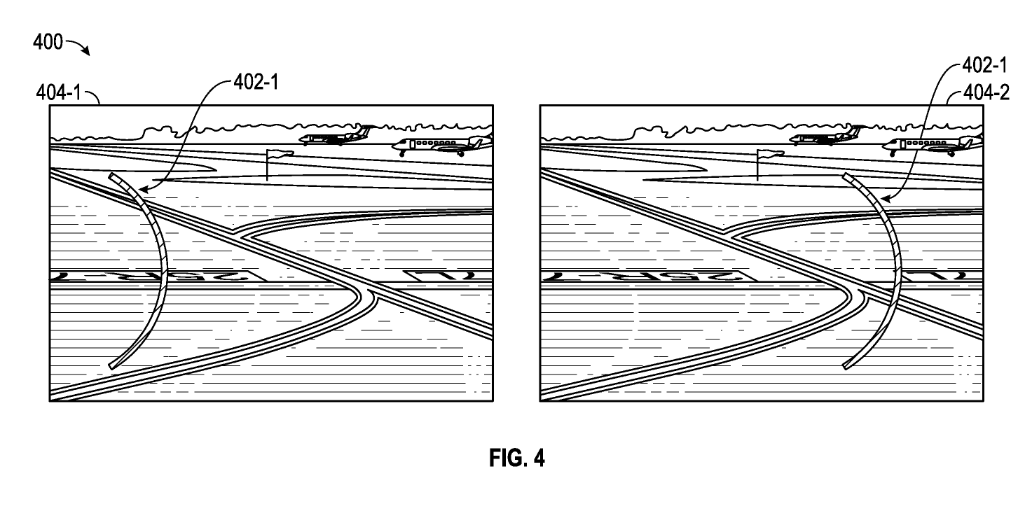

In FIG. 4, a display 400 presents the overlays 401-1, 402-2 within the FOVs 404-1, 404-2. In the example of FIG. 4, the overlays 401-1, 402-2 are displayed as arcs headed in a port direction indicating that the aircraft is turning in the port direction.

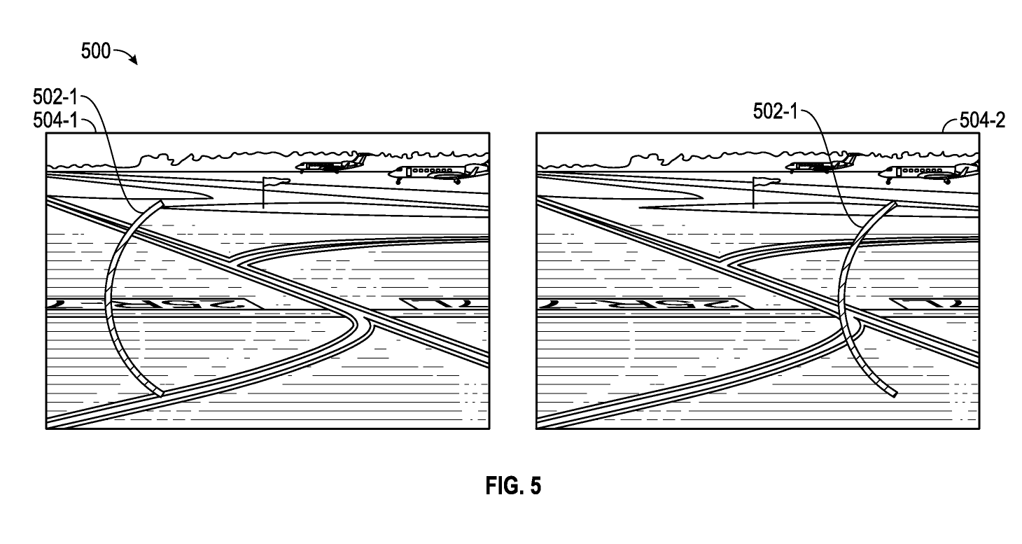

In FIG. 5, a display 500 presents the overlays 501-1, 502-2 within the FOVs 504-1, 504-2. In the example of FIG. 5, the overlays 501-1, 502-2 are displayed as arcs headed in a starboard direction indicating that the aircraft is turning in the starboard direction.

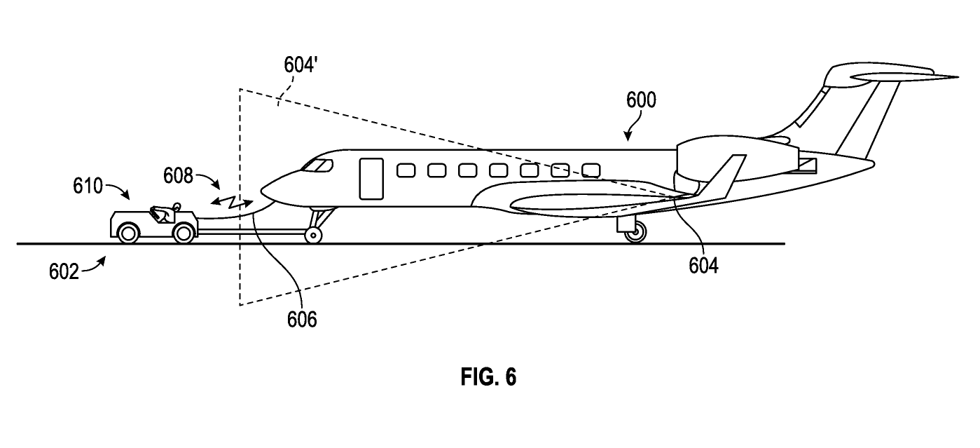

In addition to displaying the predicted path of the wingtips to operators within a taxiing aircraft, the present disclosure contemplates displaying the predicted path of the wingtips to operators of towing equipment that may be moving the aircraft into or out of a hanger or maneuvering an aircraft away from a boarding gate. In this embodiment, it may be even more difficult for an operator to estimate wingtip path visually due to the lower point of view of being in the towing equipment. Accordingly, FIG. 6 illustrates an aircraft 600 being towed by towing equipment 602. The aircraft 600 includes wingtip cameras 604 (only one shown in FIG. 6) having a field of view 604′. The wingtip camera images (see FIGS. 3-5) and overlays showing the predicted path of the wingtips is transmitted to the towing equipment 602 via a cable 606 connection or via a wireless 608 connection. This information is presented to the operator of the towing equipment 602 on a display 610 within the towing equipment 602 providing a wingtip view to the operator of the towing equipment along with the predicted path of the wingtips. Optionally, in wireless embodiments, the camera images and the predicted path of the wingtips could be transmitted to a table computer or other device carried by the operator of the towing equipment 602.

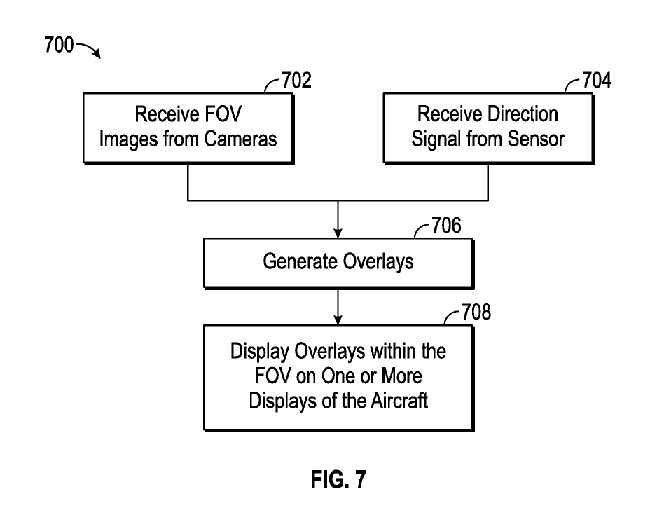

FIG. 7 is a flowchart of a method 700 illustrating the steps performed by the The various tasks performed in connection with the method 700 of FIG. 7 may be performed by software executed in a processing unit, hardware, firmware, or any combination thereof For illustrative purposes, the following description of the method 700 of FIG. 7 may refer to elements mentioned above in connection with FIGS. 1-6. In practice, portions of the method of FIG. 7 may be performed by different elements of the described system. It should also be appreciated that the method of FIG. 7 may include any number of additional or alternative tasks and that the method of FIG. 7 may be incorporated into a more comprehensive procedure or process having additional functionality not described in detail herein. Moreover, one or more of the tasks shown in FIG. 7 could be omitted from an embodiment of the method 700 of FIG. 7 as long as the intended overall functionality remains intact.

The routine begins in step 702, where video images is received from the cameras (110-1, 110-2 in FIG. 1A) to provide wingtip FOVs 110-1′ and 110-2′. Also, step 704 receives a direction signal indicating a forward direction (including steering information) from a sensor, such as, for example, a landing gear sensor (112 in FIG. 1A). In step 706, the overlays are generated that indicate a predicted path the wingtips will take through the FOVs 110-1′ and 110-2′. As noted above, if the cameras (110-1, 110-2 in FIG. 1A) cannot be physically positioned at the wingtip, a computer (202 in FIG. 2) can compensate for the distance to the actual wingtip since the distance from the center of the FOVs to the wingtip would be known for any particular embodiment. In step 708, the overlays are displayed within the FOVs (110-1′, 110-2′ in FIG. 1A). The display may be a conventional cockpit screen display, a head-up display, or a display in towing equipment towing the aircraft. Optionally, the overlays may be presented via color features or with other information.

The disclosed methods and systems provide an optical wingtip monitoring system for an aircraft that enhances safe ground travel for an aircraft by an operator with a visual indicator of the path of the wingtips relative to the forward direction of the aircraft as being directed by the operator. This allows the operator an opportunity to identify potential collisions in time to avoid the collision for the safety of the aircraft and convenience of the passengers.

It will be appreciated that the various illustrative logical blocks/tasks/steps, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The word “exemplary” is used exclusively herein to mean “serving as an example, instance, or illustration.” Any embodiment described herein as “exemplary” is not necessarily to be construed as preferred or advantageous over other embodiments.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

1. A method for avoiding a collision between an aircraft on a ground surface and an obstacle, the method comprising:
receiving, at a processor onboard the aircraft, a direction signal from a sensor, the direction signal indicating a direction of the aircraft; and
receiving, at the processor onboard an aircraft, a video image from a camera, the video image representing a field of view from a wing of the aircraft;
determining, by the processor, a predicted path through which the wing of the aircraft will travel based upon the direction signal; and
displaying the video image on a display together with an overlay representing the predicted path in the first field of view;
wherein the overlay provides information to assist in preventing the aircraft from colliding with obstacles in the field of view.

2. The method of claim 1, wherein displaying comprises displaying the video image and the overlay on a display within the aircraft.

3. The method of claim 1, wherein displaying comprises displaying the video image and the overlays on a head-up display.

4. The method of claim 1, wherein displaying comprises displaying the video images and the overlay on a display in towing equipment towing the aircraft.

5. The method of claim 1, wherein receiving the direction signal comprises receiving the direction signal from a sensor indicating a steering position of a front landing gear of the aircraft.

6. The method of claim 1, wherein displaying the overlay comprises displaying a substantially straight line when the direction signal indicates that the aircraft is headed in a substantially straight direction.

7. The method of claim 6, wherein displaying the overlay comprises displaying an arced line when the direction signal indicates that the aircraft is turning away from the substantially straight direction.

8. A method for avoiding a collision between an aircraft on a ground surface and an obstacle, the method comprising:
receiving, at a processor onboard the aircraft, a direction signal from a sensor, the direction signal indicating the direction of the aircraft; and
receiving, at the processor onboard an aircraft, a first video image from a first camera, the first video image representing a first field of view from a first wing of the aircraft;
receiving, at the processor onboard an aircraft, a second video image from a second camera, the second video image representing a second field of view from a second wing of the aircraft;
determining, by the processor, a first predicted path through which the first wing of the aircraft will travel and a second predicted path through which the second wing of the aircraft will travel based upon the direction signal; and
displaying the first video image on a display together with an overlay representing the first predicted path in the first field of view, and the second video image on the display together with an overlay representing the second predicted path in the second field of view;
wherein the first and second overlays provide information to assist in preventing the aircraft from colliding with obstacles in the first and second field of views.

9. The method of claim 8, wherein displaying comprises displaying the first and second video images and the first and second overlays on a display within the aircraft.

10. The method of claim 8, wherein displaying comprises displaying the first and second video images and the first and second overlays on a head-up display.

11. The method of claim 8, wherein displaying comprises displaying the first and second video images and the first and second overlays on a display in towing equipment towing the aircraft.

12. The method of claim 8, wherein receiving the direction signal comprises receiving the direction signal from a sensor indicating a steering position of a front landing gear of the aircraft.

13. The method of claim 8, wherein displaying the first and second overlays comprises displaying substantially straight lines when the direction signal indicates that the aircraft is headed in a substantially straight direction.

14. The method of claim 8, wherein displaying the first and second overlays comprises displaying arced lines when the direction signal indicates that the aircraft is turning away from the substantially straight direction.

15. An aircraft, comprising:
a sensor providing a direction signal indicating a direction of the aircraft;
a camera for providing video image within a wing field of view of the aircraft;
processor for determining a predicted path for a wing of the aircraft within the wingtip field of view based upon the direction signal and for generating an overlay image representing the predicted path; and
a display for displaying the video image and the overlay to provide information to assist in avoiding obstacles.

16. The aircraft according to claim 15, wherein the sensor comprise a steering sensor on a landing gear of the aircraft.

17. The aircraft according to claim 15, wherein the display comprises a display within the aircraft or in towing equipment towing the aircraft.
